(19) United States
(12) Patent Application Publication
(10) Pub. No.: US 2014/0376625 A1
(43) Pub. Date: Dec. 25, 2014

(54) INTRA PREDICTION METHOD AND ELECTRONIC DEVICE THEREFOR

(71) Applicant: MIICS & PARTNERS INC., Road Town (VG)

(72) Inventors: CHUNG-I LEE, New Taipei (TW); MING-HUA TANG, New Taipei (TW)

(21) Appl. No.: 14/314,251

(22) Filed: Jun. 25, 2014

(30) Foreign Application Priority Data
Jun. 25, 2013 (TW) 102122449

(51) Int. Cl. H04N 19/593

(52) U.S. Cl. CPC H04N 19/00763
USPC 375/240.12

(57) ABSTRACT

An intra prediction method executed by a processor of an electronic device is disclosed. The method allows the electronic device to obtain a prediction unit of an image, and to set a search range for the prediction unit based on a reconstruction region of the image. The search range includes a plurality of predicted blocks. The electronic device further measures similarities between the prediction unit and each of the plurality of predicted blocks, determines a reference block based on the similarities, and predicts the prediction unit based on the reference block.

### CROSS-REFERENCE TO RELATED APPLICATIONS

This application claims priority to Taiwanese Patent Application No. 102122449 filed on Jun. 25, 2013 in the Taiwan Intellectual Property Office, the contents of which are incorporated by reference herein.

### FIELD

The subject matter herein generally relates to an electronic device, and particularly to an electronic device including an intra prediction system and an intra prediction method executed by the electronic device.

### BACKGROUND

A new video coding algorithm is currently being prepared in order to support 4K resolution, 8K resolution, and other better resolution. The main goal is to improve compression performance relative to existing algorithms.

### BRIEF DESCRIPTION OF THE DRAWINGS

Implementations of the present technology will now be described, by way of example only, with reference to the attached figures, wherein:

FIG. 1 is a block diagram of one embodiment of an electronic device including an intra prediction system.

FIG. 2 is a schematic diagram of one embodiment of a partitioned LCU in an image.

FIG. 3 is a schematic diagram of one embodiment of an encoding sequence of a coding unit.

FIG. 4 is a block diagram of one embodiment of function modules of the intra prediction system in the electronic device of FIG. 1.

FIG. 5 illustrates a flowchart of one embodiment of an intra prediction method for the electronic device of FIG. 1.

FIG. 6 is a schematic diagram of one embodiment of a partitioned LCU in an image.

FIG. 7 is a schematic diagram of one embodiment of a search range of a coding unit in an image.

FIG. 8 is a schematic diagram of one embodiment of a search range of a coding unit in an image.

FIG. 9 is a block diagram of one embodiment of an electronic device including an intra prediction reconstruction system.

FIG. 10 is a block diagram of one embodiment of function modules of the intra prediction reconstruction system in the electronic device of FIG. 9.

FIG. 11 illustrates a flowchart of one embodiment of an intra prediction reconstruction method for the electronic device of FIG. 9.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

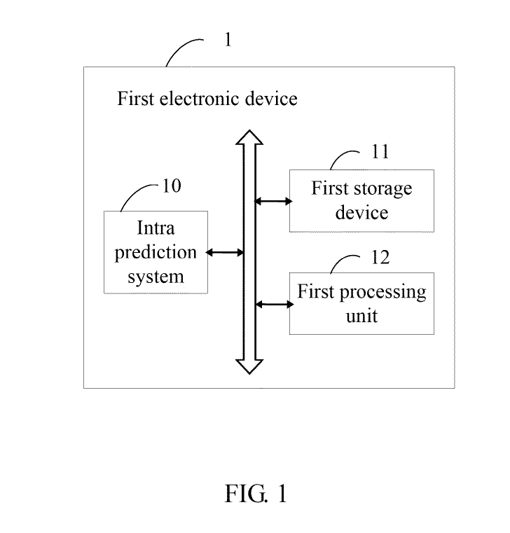

FIG. 1 illustrates an embodiment of a first electronic device 1 including an intra prediction system 10. In the embodiment, the electronic device 10 can include a first storage device 11, and a first processing unit 12. The first storage device 11 can store a plurality of instructions and be coupled to the first processing unit 12. When the plurality of instructions are executed by the first processing unit 12, the first processing unit 12 obtains a prediction unit of an image, sets a search range for the prediction unit based on a reconstruction region of the image. In an embodiment, the prediction unit (PU) is a region, defined by partitioning a coding unit (CU) in the image, on which a prediction process is applied. The search range includes a plurality of predicted blocks. Then, the first processing unit 12 measures similarities between the prediction unit and each of the plurality of predicted blocks, determines a reference block based on the similarities, and predicts the prediction unit based on the reference block.

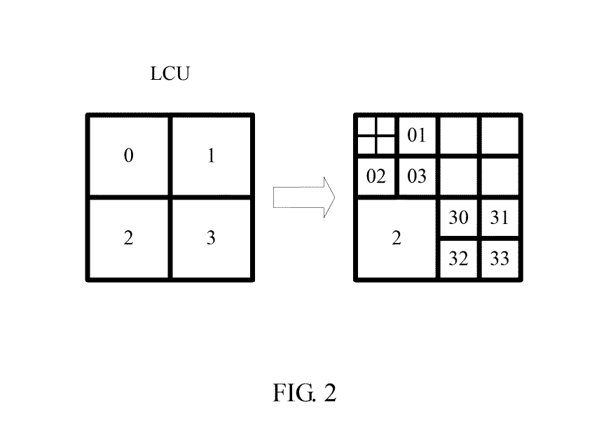

When the image is encoded, the first processing unit 12 can obtain a prediction unit of an image from the first storage device 11 or other electronic device, such as an external electronic device. The image can be partitioned into a plurality of largest coding units (LCUs) each having a fixed size, such as 64×64 pixels. Referring to FIG. 2, each of the plurality of LCUs can be recursively partitioned into a plurality of coding units having different sizes using a quad-tree partition. For example, a 64×64 LCU can be partitioned into four 32×32 CUs represented as CU0, CU1, CU2, and CU3. A 32×32 CU can be partitioned into four 16×16 CUs, like CU00, CU01, CU02 and CU03. A 16×16 CU can be further partitioned into four 8×8 CUs. In one embodiment, the prediction unit can be predicted by using intra prediction or inter prediction.

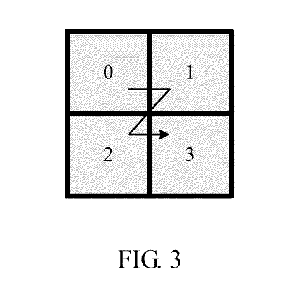

In one embodiment, the plurality of coding units are encoded from CU0 to CU3 in sequence, as shown in FIG. 3. Each of the plurality of coding units can be predicted based on a plurality of reconstructed blocks. In the embodiment, a block which has been predicted to generate residuals is reconstructed to be a reconstructed block based on the residuals for subsequent prediction. For example, before the CU1 is predicted, the CU0, a block on the top of the CU1, and another block on the upper-left of the CU1 have been predicted for providing bit steam to a decoding device and reconstructed in the first electronic device 1 for subsequent prediction. The reconstructed blocks can be predicted blocks of the CU1 which are reference candidates for predicting the CU1. When the CU2 is predicted, the CU0, the CU1, a block on the left side of the CU2 and another block on the upper-left of the CU2 can be reconstructed to be predicted blocks of the CU2.

In one embodiment, the intra prediction system 10 can further include a plurality of directional prediction modes, such as a vertical mode and a horizontal mode, and a plurality of non-directional prediction modes, such as a direct current (DC) mode, and a planar mode. Thus, the prediction unit can be predicted by the block-based prediction, a directional-based prediction and a non-directional based prediction of the intra prediction system 10. In one embodiment, the plurality of directional prediction modes and the plurality of non-directional prediction modes can be 34 intra prediction modes defined in High Efficiency Video Coding (HEVC).

In one embodiment, the first processing unit 12 can set a search range for the prediction unit based on a reconstruction region of the image. The reconstruction region of the image is a region of the image in which all the blocks have been predicted. The search range includes a plurality of predicted blocks having the same size as the prediction unit. In one embodiment, each of the plurality of predicted blocks is in contact with the prediction unit. In one embodiment, the search range is set around the prediction unit based on a size of the prediction unit. In one embodiment, if the prediction unit is included in a first one of the plurality of LCUs, the search range can include a second one of the plurality of LCUs on the top of the first one of the plurality of LCUs. In addition, the search range can include a third one of the plurality of LCUs on the left side of the first one of the plurality of LCUs. In one embodiment, the search range can be generated in the second one of the LCUs, the third one of the LCUs or the combination of the second and third one of the LCUs.

In one embodiment, the first processing unit 12 can measure deviation between the prediction unit and each of the plurality of predicted blocks to generate the similarities. For example, the first processing unit 12 measures the similarities based on sum of absolute transformed difference (SATD) or sum of absolute difference (SAD).

In one embodiment, the first processing unit 12 can select a specific number of the plurality of predicted blocks based on the similarities. The specific number of the plurality of predicted blocks have a higher similarity than the other of the plurality of predicted blocks. In one embodiment, the first processing unit 12 can further determine the reference block based on a measurement, such as coding cost, which is different from the similarity measurement. For example, the first processing unit 12 can use rate distortion optimization (RDO) technique to obtain one of the selected predicted blocks having a minimum coding cost, and determine the one of the selected predicted block as the reference block.

In an embodiment, the first processing unit 12 can predict the prediction unit based on the reference block by measuring residuals between the pixels of the prediction unit and the corresponding pixels of the reference block. If the prediction of the image has ended, the first processing unit 12 can predict a next image or end the procedure.

The first storage device 11 can be a non-volatile computer readable storage medium that can be electrically erased and reprogrammed, such as ROM, RAM, EPROM, EEPROM, hard disk, solid state drive, or other forms of electronic, electromagnetic or optical recording medium. In one embodiment, such first storage device 11 can include interfaces that can access the aforementioned computer readable storage medium to enable the first electronic device 1 to connect and access such computer readable storage medium. In another embodiment, the first storage device 11 can include network accessing device to enable the first electronic device 1 to connect and access data stored in a remote server or a network-attached storage.

The first processing unit 12 can be a processor, a central processing unit (CPU), a graphic processing unit (GPU), a system on chip (SoC), a field-programmable gate array (FPGA), or a controller for executing the program instruction in the first storage device 11 which can be SRAM, DRAM, EPROM, EEPROM, flash memory or other types of computer memory. The first processing unit 12 can further include an embedded system or an application specific integrated circuit (ASIC) having embedded program instructions.

In one embodiment, the first electronic device 1 can be a server, a desktop computer, a laptop computer, a game console, a set-top box, a television, a camera, a video recorder or other electronic device. Moreover, FIG. 1 illustrates only one example of an electronic device 10, that can include more or fewer components than illustrated, or have a different configuration of the various components in other embodiments.

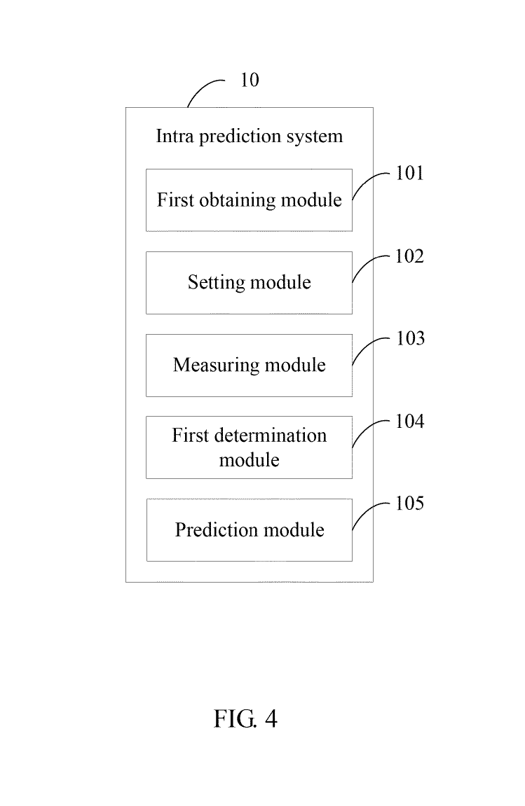

FIG. 4 illustrates an embodiment of function modules of the intra prediction system 10 in the electronic device 1 of FIG. 1. In at least one embodiment, the intra prediction system 10 can include one or more modules, for example, a first obtaining module 101, a setting module 102, a measuring module 103, a first determination module 104, and a prediction module 105. A “module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable medium include CDs, DVDs, BLU-RAY, flash memory, and hard disk drives.

The first obtaining module 101 can obtain a prediction unit of an image from a first storage device 11 or other electronic device, such as an external electronic device. The prediction unit is partitioned from the image. The setting module 102 can set a search range for the prediction unit based on a reconstruction region of the image. The reconstruction region of the image is a region of this image in which all the blocks have been predicted. The search range includes a plurality of predicted blocks having the same size as the prediction unit. The measuring module 103 can measure similarities between the prediction unit and each of the plurality of predicted blocks. The first determination module 104 can select a specific number of the plurality of predicted blocks based on the similarities. The first determination module 104 can further determine a reference block of the prediction unit from the selected predicted blocks by a method different from the similarities, such as using a cost function. The prediction module 105 can predict the prediction unit based on the reference block. In an embodiment, the prediction module 105 can predict the prediction unit based on the reference block by measuring residuals between the pixels of the prediction unit and the corresponding pixels of the reference block.

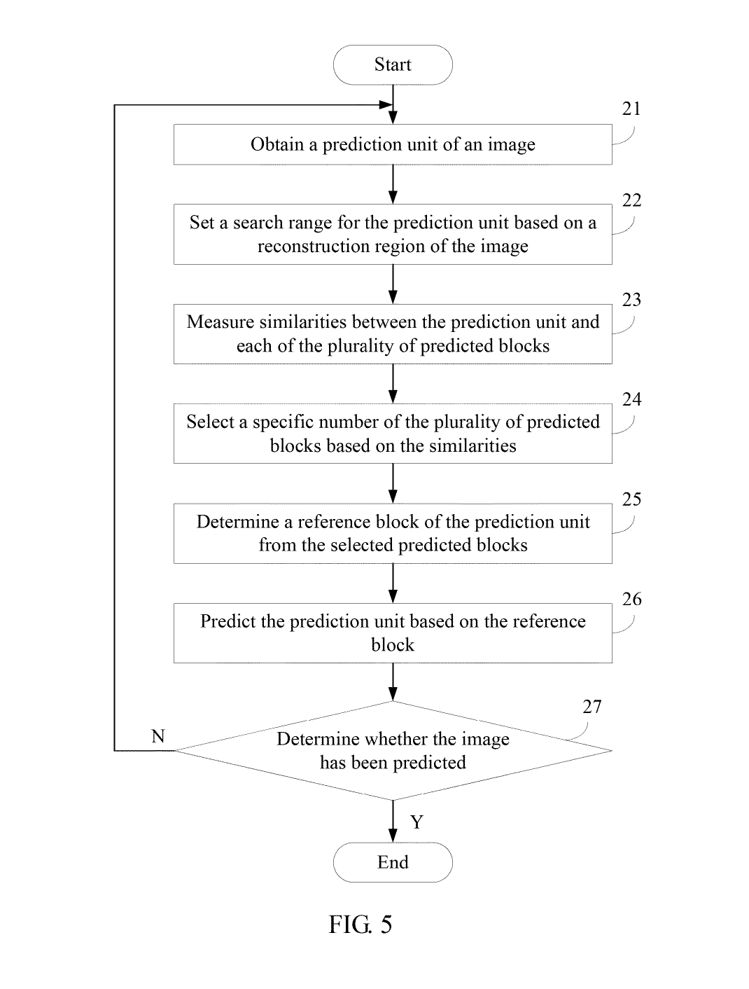

FIG. 5 illustrates a flowchart of one embodiment of an intra prediction method for the electronic device 1 of FIG. 1.

Referring to FIG. 5, a flowchart is presented in accordance with an example embodiment. The example method is provided by way of example, as there are a variety of ways to carry out the method. The method described below can be carried out using the configurations illustrated in FIGS. 1 and 4, for example, and various elements of these figures are referenced in explaining example method. Each block shown in FIG. 5 represents one or more processes, methods or subroutines, carried out in the example method. Furthermore, the illustrated order of blocks is illustrative only and the order of the blocks can change according to the present disclosure. Additional blocks can be added or fewer blocks can be utilized, without departing from this disclosure. The example method can begin at block 21.

At block 21, the first obtaining module 101 obtains a prediction unit of an image from a first storage device 11 or other electronic device, such as an external electronic device. Referring to FIG. 2, the image can be partitioned into a plurality of largest coding units (LCUs) each having a fixed size, such as 64×64 pixels. Each of the plurality of LCUs can be recursively partitioned into a plurality of coding units having different sizes using a quad-tree partition until a specific size, such as 8×8 pixels. For example, a 64×64 LCU can be partitioned into four 32×32 CUs represented as CU0, CU1, CU2, and CU3. A 32×32 CU can be partitioned into four 16×16 CUs, like CU00, CU01, CU02 and CU03. A 16×16 CU can be further partitioned into four 8×8 CUs. In the embodiment, each of the above-mentioned partitions can be a prediction unit or can be further partitioned into N×M sub-partitions as prediction units.

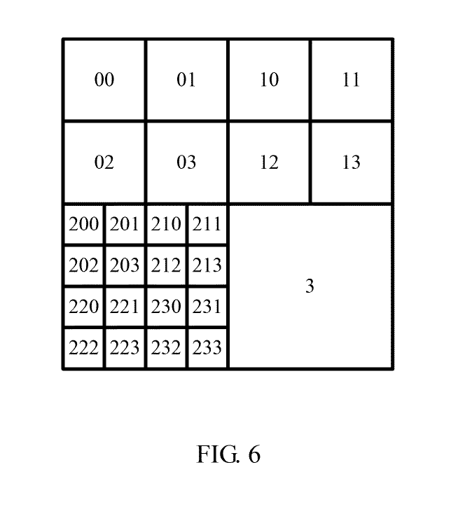

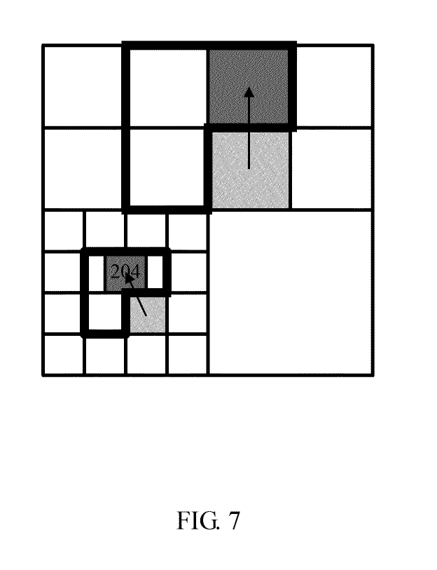

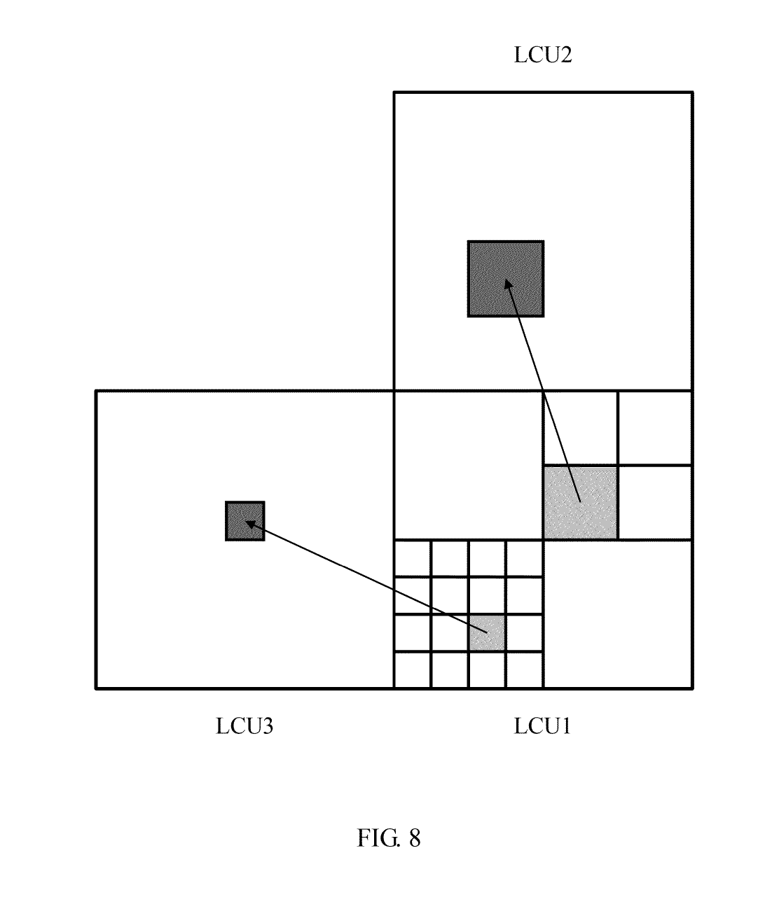

At block 22, the setting module 102 sets a search range for the prediction unit based on a reconstruction region of the image. The reconstruction region of the image is a region of this image in which all the blocks have been predicted. The search range includes a plurality of predicted blocks having the same size as the prediction unit. In one embodiment, each of the plurality of predicted blocks is in contact with the prediction unit. In one embodiment, the search range is set around the prediction unit based on a size of the prediction unit. Referring to FIGS. 6-7, a LCU is partitioned into a 32×32 CU CU3, eight 16×16 CUs CU00-CU03 and CU10-CU13, and sixteen 8×8 CUs CU200-203, CU210-213, CU220-223, and CU230-233. When the prediction unit is CU12, the search range of the CU12 can includes the covered areas of CU01, CU10, and CU03. When the prediction unit is CU230, the search range of the CU230 can includes the covered areas of CU203, CU212, and CU221. In one embodiment, if the prediction unit is included in a first one of the plurality of LCUs, the search range can include a second one of the plurality of LCUs on the top of the first one of the plurality of LCUs. In addition, the search range can include a third one of the plurality of LCUs on the left side of the first one of the plurality of LCUs. Referring to FIG. 8, if the prediction unit is included in LCU1, the search range can include LCU2. In addition, the search range also can include LCU3. In one embodiment, the search range can be formed in the LCU2 or LCU3. In one embodiment, the search range can be formed in the LCU2 and LCU3.

In one embodiment, a CU which has been predicted in the search range of the image can be one of the plurality of predicted blocks. In addition, an intermediate block sifted from a CU in the search range also can be one of the plurality of predicted blocks. For example, when the prediction unit is CU230, each of CU203, CU212, CU221, and CU204 can be one of the plurality of predicted blocks.

At block 23, the measuring module 103 measures similarities between the prediction unit and each of the plurality of predicted blocks. The measuring module 103 can measure deviation between the prediction unit and each of the plurality of predicted blocks to generate the similarities. In one embodiment, the measuring module 103 measures the similarities based on sum of absolute transformed difference (SATD) or sum of absolute difference (SAD).

At block 24, the first determination module 104 selects a specific number of the plurality of predicted blocks based on the similarities. The specific number of the plurality of predicted blocks have a higher similarity than the other of the plurality of predicted blocks. In one embodiment, the similarities are arranged from high to low by the first determination module 104. Then, the first determination module 104 can select the specific number of the plurality of predicted blocks with higher similarities. For example, the first determination module 104 can select five predicted blocks based on the similarities.

At block 25, the first determination module 104 determines a reference block of the prediction unit from the selected predicted blocks. In the embodiment, the reference block is selected from the predicted blocks for generating residuals between the reference block and the prediction unit. The first determination module 104 can determine the reference block based on a measure which is different from that of the measuring module 103. In one embodiment, the first determination module 104 can determine the reference block based on coding cost. The coding cost can be relevant to the similarity measurement. For example, the first determination module 104 can use rate distortion optimization (RDO) technique to obtain one of the selected predicted blocks having a minimum coding cost, and determine the one of the selected predicted block as the reference block. In one embodiment, the first determination module 104 determinates location information of the reference block for reconstructing the reference block during the reconstruction process.

In one embodiment, blocks 24-25 can be combined to execute by the first determination module 104. When the first determination module 104 selects a specific number of the plurality of predicted blocks based on the similarities, the first determination module 104 can select by simultaneously considering other criteria, such as RDO. In addition, the specific number can be set as one. Thus, the first determination module 104 can directly select one of the plurality of the predicted blocks based on the similarities and/or other criteria.

At block 26, the prediction module 105 predicts the prediction unit based on the reference block. In one embodiment, the prediction unit includes a plurality of pixels, and the reference block also includes a plurality of pixels. Each of the plurality of pixels in the prediction unit corresponds to one of the plurality of pixels in the reference block. The prediction module 105 can measure residuals between the pixels of the prediction unit and the corresponding pixels of the reference block to generate predicted values. Referring to FIGS. 6 and 7, if the prediction unit is CU12 and the reference block is CU10, the residuals between the pixels of CU12 and the corresponding pixels of CU10 is measured for prediction. If the prediction unit is CU230 and the reference block is a selected block between CU203 and 212, for example CU204, the residuals between the pixels of CU230 and the corresponding pixels of CU204 is measured for prediction. In one embodiment, the predicted values and the location information can be a prediction result of the prediction unit.

At block 27, the prediction module 105 determines whether the image has been predicted or not. If the image has been predicted, the procedure ends. If the image has not been predicted, there is any other prediction unit which has not been predicted in the image, and the procedure goes to block 21.

In one embodiment, the prediction unit can be predicted independently by the block-based prediction of this intra prediction system 10 during intra prediction. In one embodiment, the intra prediction system 10 can further include a plurality of directional prediction modes, such as a vertical mode and a horizontal mode, and a plurality of non-directional prediction modes, such as a direct current (DC) mode, and a planar mode. Thus, the prediction unit can be predicted by the block-based prediction, the directional-based prediction and the non-directional based prediction of this intra prediction system 10.

When the prediction unit is predicted by the block-based prediction, the direction-based prediction, and the non-directional based prediction of the intra prediction system 10, the intra prediction system 10 can select a specific number of prediction modes from the plurality of directional prediction modes and the plurality of non-directional prediction modes. The specific number of prediction modes and the specific number of the plurality of predicted blocks are determined as predicted candidates. For example, the intra prediction system 10 can select three directional prediction modes and three predicted blocks to be predicted candidates for predicting the prediction unit based on SATD or SAD. Then, the first determination module 104 can determine the best candidate from the predicted candidates. In one embodiment, the best candidate can be determined based on the coding cost, such as RDO. In one embodiment, the best candidate has a minimum coding cost for the predicting the prediction unit. If the best candidate is a reference block, the prediction unit is predicted by measuring the residuals between the reference block and the prediction unit based on the block-based prediction. If the best candidate is a prediction mode, the prediction unit is predicted by measuring the residuals based on the direction-based prediction or the non-directional based prediction.

After the prediction unit is predicted during an encoding process, the prediction unit can be encoded in a transformation process, a quantization process, and an entropy coding process to generate a bit stream. The bit stream can be stored in the first storage device 11 or other electronic devices. In addition, the bit stream can be read and decoded to display the image by the first electronic device 1 or other electronic devices. Thus, the bit stream can be reconstructed by an intra prediction reconstruction system.

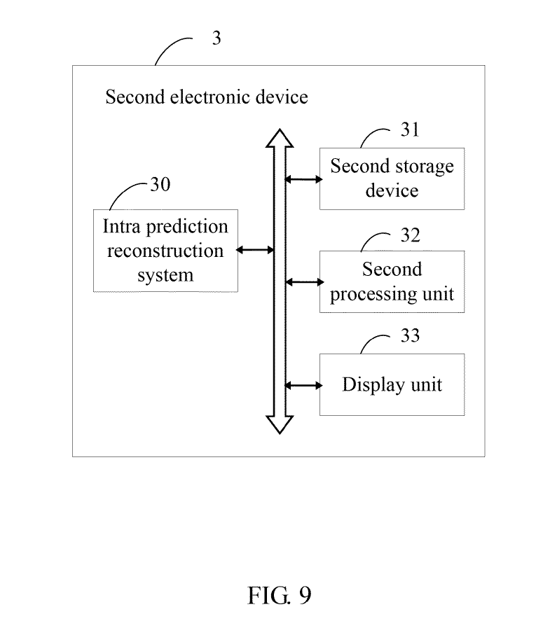

FIG. 9 illustrates an embodiment of a second electronic device 3 including an intra prediction reconstruction system 30. In the embodiment, the second electronic device 30 can include a second storage device 31, and a second processing unit 32. In addition, the second electronic device 30 can further include a display unit 33. The second storage device 31 can store a plurality of instructions. When the plurality of instructions are executed by the second processing unit 32, the second processing unit 32 obtains a prediction result of a prediction unit in an image, and obtains a reference block in a reconstruction region of the image based on the prediction result. The reference block is one of a plurality of predicted blocks included in a search range of the reconstruction region. Then, the second processing unit 32 reconstructs the prediction unit based on the reference block.

When the image is decoded, the second processing unit 32 can obtain a prediction result of a prediction unit in an image from a second storage device 31 or other electronic device, such as an external electronic device. The image can be partitioned into a plurality of largest coding units (LCUs) during an encoding process, and further recursively partitioned into a plurality of coding units. In one embodiment, the prediction unit is formed based on the plurality of coding units for prediction and predicted to obtain the prediction values and location information. In one embodiment, the plurality of coding units is also decoded from CU0 to CU3 in sequence, as shown in FIG. 3. Each of the plurality of coding units can be reconstructed based on its reference block.

In one embodiment, the second processing unit 32 can determine the reference block of the prediction unit in a reconstruction region of the image based on the prediction result. The reconstruction region of the image is a region of the image in which all the blocks have been reconstructed. For example, before CU3 is reconstructed, CU0 to CU2 have been reconstructed. Thus, when CU3 is being reconstructed, the reconstruction region including CU0 to CU2 has all the blocks of the image which have been reconstructed before reconstructing CU3. The reference block is searched from a search range during an encoding process. The search range includes a plurality of predicted blocks having the same size as the prediction unit. In one embodiment, each of the plurality of predicted blocks is in contact with the prediction unit. In one embodiment, the search range is set around the prediction unit based on a size of the prediction unit. In one embodiment, if the prediction unit is included in a first one of the CUs, the search range can include a second one of the LCUs on the top of the first one of the LCUs. In addition, the search range can include a third one of the LCUs on the left side of the first one of the LCUs. In one embodiment, the second processing unit 32 determines the reference block based on the location information of the prediction result.

In one embodiment, the second processing unit 32 can reconstruct the prediction unit based on the reference block and the predicted values of the prediction unit. Each of the predicted values is a residual between a pixel of the prediction unit and a corresponding pixel of the reference block. In one embodiment, the reconstruction module 303 reconstructs all of the pixels in the prediction unit based on a plurality of reconstructed pixels of the reference block and the residuals between the pixels of the prediction unit and the corresponding pixels of the reference block.

In one embodiment, the display unit 33 can display the reconstructed image. Thus, the display unit 33 can comprise a display device using LCD (liquid crystal display) technology, or LPD (light emitting polymer display) technology, although other display technologies can be used in other embodiments. The display unit 33 can comprise a projector instead of the aforementioned display device. The display device can be a panel display device or a curved display device having a resolution of 2 k, 4 k or 8 k, or other better resolution. In another embodiment, the display unit 33 can comprise any video interface for transferring data which can be implemented by adopting customized protocols or by following existing standards or de facto standards including High-Definition Multimedia Interface (HDMI), Video Graphics Array (VGA), DisplayPort, Thunderbolt, Lightning Bolt, Universal Serial Bus (USB), Micro Universal Serial Bus (Micro USB) or Mobile High-Definition Link (MHL). In some embodiment, the display unit 33 can further comprise a customized connector or a standard connector such as HDMI connector, VGA connector, DisplayPort connector, Mini DisplayPort (MDP) connector, USB connector, Thunderbolt connector or Lightning connector. In other embodiments, the display unit 33 can also be implemented as a wireless chip adopting customized protocols or following existing wireless standards or de facto standards such as IEEE 802.11 series (Wireless Local Area Network, WLAN) including Wi-Fi series or Wireless Gigabit Alliance (WiGig) Standard, IEEE 802.11 series including Bluetooth, Miracast, Digital Living Network Alliance (DLNA) Standard, Wireless Home Digital Interface (WHDI), WirelessHD standard, Wireless USB, WiDi, Allshare or Airplay.

The second storage device 31 can be a non-volatile computer readable storage medium that can be electrically erased and reprogrammed, such as ROM, RAM, EPROM, EEPROM, hard disk, solid state drive, or other forms of electronic, electromagnetic or optical recording medium. In one embodiment, such second storage device 31 can include interfaces that can access the aforementioned computer readable storage medium to enable the second electronic device 3 to connect and access such computer readable storage medium. In another embodiment, the second storage device 31 can include network accessing device to enable the second electronic device 3 to connect and access data stored in a remote server or a network-attached storage.

The second processing unit 32 can be a processor, a central processing unit (CPU), a graphic processing unit (GPU), a system on chip (SoC), a field-programmable gate array (FPGA), or a controller for executing the program instruction in the second storage device 31 which can be SRAM, DRAM, EPROM, EEPROM, flash memory or other types of computer memory. The second processing unit 32 can further include an embedded system or an application specific integrated circuit (ASIC) having embedded program instructions.

In one embodiment, the first electronic device 3 can be a server, a desktop computer, a laptop computer, a game console, a set-top box, a television, a camera, a video recorder or other electronic device. Moreover, FIG. 9 illustrates only one example of a second electronic device 3, that can include more or fewer components than illustrated, or have a different configuration of the various components in other embodiments.

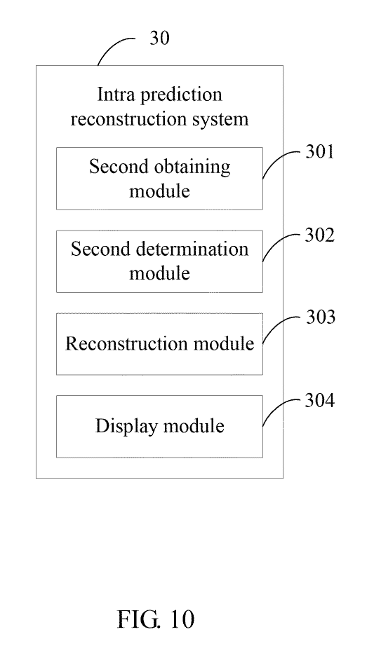

FIG. 10 illustrates an embodiment of function modules of the intra prediction reconstruction system 30 in the second electronic device 3 of FIG. 9. In at least one embodiment, the intra prediction reconstruction system 30 can include one or more modules, for example, a second obtaining module 301, a second determination module 302, a reconstruction module 303 and a display module 304. A “module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable medium include CDs, DVDs, BLU-RAY, flash memory, and hard disk drives.

The second obtaining module 301 can obtain a prediction result of a prediction unit in an image from a second storage device 31 or other electronic device, such as an external electronic device. The prediction result can include predicted values of the prediction unit, and location information indicated where a reference block of the prediction unit is located. In one embodiment, the predicted values are residuals between pixels of the prediction unit and corresponding pixels of the reference block. The second determination module 302 can determine the reference block of the prediction unit in a reconstruction region of the image based on the location information of the prediction result. The reconstruction module 303 can reconstruct the prediction unit based on the reference block and the predicted values of the prediction unit. The display module 304 can display the reconstructed image when the image has been reconstructed.

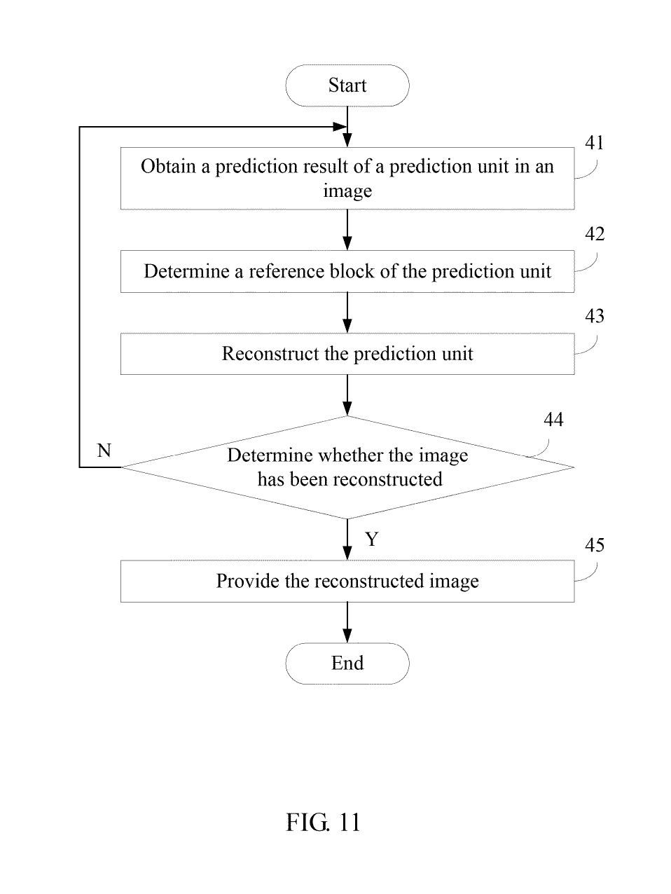

FIG. 11 illustrates a flowchart of one embodiment of an intra prediction reconstruction method for the second electronic device 3 of FIG. 9.

Referring to FIG. 11, a flowchart is presented in accordance with an example embodiment. The example method is provided by way of example, as there are a variety of ways to carry out the method. The method described below can be carried out using the configurations illustrated in FIGS. 9 and 10, for example, and various elements of these figures are referenced in explaining example method. Each block shown in FIG. 11 represents one or more processes, methods or subroutines, carried out in the example method. Furthermore, the illustrated order of blocks is illustrative only and the order of the blocks can change according to the present disclosure. Additional blocks can be added or fewer blocks can be utilized, without departing from this disclosure. The example method can begin at block 41.

At block 41, the second obtaining module 301 obtains a prediction result of a prediction unit in an image from a second storage device 31 or other electronic device, such as an external electronic device. The prediction result can include predicted values of the prediction unit, i.e. residuals of the prediction unit, and location information indicated where a reference block of the prediction unit is located. Referring to FIG. 2, the image can be partitioned into a plurality of largest coding units (LCUs) during an encoding process, and further recursively partitioned into a plurality of coding units. Then, the prediction unit is formed based on the plurality of coding units for prediction and predicted to obtain the prediction values and location information. Referring to FIGS. 7 and 8, if the prediction unit is CU12 and the reference block is CU10, the prediction result of the CU12 can includes the residuals of the CU12 and the location information of the CU10. If the prediction unit is CU230 and the reference block is a predicted block between CU203 and CU212, the prediction result of the CU230 can includes the residuals of the CU230 and the location information of the predicted block. In one embodiment, the location information can be a relative location or a vector between the prediction unit and the reference block. In one embodiment, the location information can directly indicate the position of the reference block.

At block 42, the second determination module 302 determines the reference block of the prediction unit in a reconstruction region of the image based on the prediction result. The reference block is one of a plurality of predicted blocks included in a search range of the reconstruction region. In one embodiment, the second determination module 302 determines the reference block based on the location information. If the location information directly indicates the position of the reference block, the second determination module 302 can directly determine the reference block. If the location information is a relative location or a vector between the prediction unit and the reference block, the second determination module can determine the reference block based on the location information and the position of the prediction unit. Referring to FIGS. 6-7, if the prediction unit is CU12 and the location information directly indicates the position of the CU10, the second determination module 302 can directly determine that the reference block of the prediction unit CU12 is CU10. If the location information of CU12 is a vector indicated to a block on the top of CU12, the second determination module 302 also determines that the reference block of the prediction unit CU12 is CU10.

At block 43, the reconstruction module 303 reconstructs the prediction unit based on the reference block. In one embodiment, the reconstruction module 303 reconstructs the prediction unit based on the reference block and the predicted values of the prediction unit. Each of the predicted values is a residual between a pixel of the prediction unit and a corresponding pixel of the reference block. Since the reference block is predicted before the prediction unit is predicted, the reference block is also reconstructed during a decoding process before the prediction unit is reconstructed. In one embodiment, the reconstruction module 303 reconstructs all of the pixels in the prediction unit based on a plurality of reconstructed pixels of the reference block and the residuals between the pixels of the prediction unit and the corresponding pixels of the reference block. Referring to FIGS. 6 and 7, if the prediction unit is CU12 and the reference block is CU10, the reconstruction module 303 can reconstruct CU12 based on the reconstructed pixels of CU10 and the residuals between the pixels of CU12 and the corresponding pixels of CU10.

At block 44, the reconstruction module 303 determines whether the image has been reconstructed or not. If the image has been reconstructed, the procedure goes to block 45. If the image has not been reconstructed, there is any other prediction unit which has not been reconstructed in the image, and the procedure goes to block 41.

At block 45, the display module 304 provides the reconstructed image. In one embodiment, the display module 304 displays the reconstructed image.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. An intra prediction method comprising:
obtaining a prediction unit of an image;
setting a search range for the prediction unit based on a reconstruction region of the image, wherein the search range includes a plurality of predicted blocks;
measuring similarities between the prediction unit and each of the plurality of predicted blocks;
determining a reference block based on the similarities; and
predicting the prediction unit based on the reference block.

2. The method according to claim 1, wherein each of the plurality of predicted blocks has the same size as the prediction unit and be in contact with the prediction unit.

3. The method according to claim 1, wherein the search range is set around the prediction unit based on a size of the prediction unit.

4. The method according to claim 1, wherein the image is divided into a plurality of largest coding units (LCUs), and the prediction unit is included in a first one of the plurality of LCUs.

5. The method according to claim 4, wherein the search range is formed in a second one of the plurality of LCUs, wherein the second one of the plurality of LCUs is configured on the top of the first one of the plurality of LCUs.

6. The method according to claim 4, wherein the search range is formed in a third one of the plurality of LCUs, wherein the third one of the plurality of LCUs is configured on the left side of the first one of the plurality of LCUs.

7. An electronic device, comprising:
a processor;
a storage device that stores a plurality of instructions, when executed by the processor, causes the processor to:
obtain a prediction unit of an image;
set a search range for the prediction unit based on a reconstruction region of the image, wherein the search range includes a plurality of predicted blocks;
measure similarities between the prediction unit and each of the plurality of predicted blocks;
determine a reference block based on the similarities; and
predict the prediction unit based on the reference block.

8. The electronic device according to claim 7, wherein each of the plurality of predicted blocks has the same size as the prediction unit and be in contact with the prediction unit.

9. The electronic device according to claim 7, wherein the search range is set around the prediction unit based on a size of the prediction unit.

10. The electronic device according to claim 7, wherein the image is divided into a plurality of largest coding units (LCUs), and the prediction unit is included in a first one of the plurality of LCUs.

11. The electronic device according to claim 10, wherein the search range includes a second one of the plurality of LCUs, wherein the second one of the plurality of LCUs is configured on the top of the first one of the plurality of LCUs.

12. The electronic device according to claim 10, wherein the search range includes a third one of the plurality of LCUs, wherein the third one of the plurality of LCUs is configured on the left side of the first one of the plurality of LCUs.

13. An intra prediction reconstruction method being executed by a processor of an electronic device, the method comprising:
obtaining a prediction result of a prediction unit in an image;
obtaining a reference block in a reconstruction region of the image based on the prediction result, wherein the reference block is one of a plurality of predicted blocks included in a search range of the reconstruction region;
reconstructing the prediction unit based on the reference block.

14. The method according to claim 13, wherein each of the plurality of predicted blocks has the same size as the prediction unit and be in contact with the prediction unit.

15. The method according to claim 13, wherein the search range is set around the prediction unit based on a size of the prediction unit.

16. The method according to claim 13, wherein the image is divided into a plurality of largest coding units (LCUs), and the prediction unit is included in a first one of the plurality of LCUs.

17. The method according to claim 16, wherein the search range is formed in a second one of the plurality of LCUs, wherein the second one of the plurality of LCUs is configured on the top of the first one of the plurality of LCUs.

18. The method according to claim 16, wherein the search range is formed in a third one of the plurality of LCUs, wherein the third one of the plurality of LCUs is configured on the left side of the first one of the plurality of LCUs.
